(19) United States
(12) Patent Application Publication
(10) Pub. No.: US 2009/0171995 A1
(43) Pub. Date: Jul. 2, 2009

(54) ASSOCIATING AND PRESENTING ALTERNATE MEDIA WITH A MEDIA FILE

(76) Inventors: Kelan Silvester, Portland, OR (US); James R. Trethewey, Hillsboro, OR (US); Walter Russell Swindell, Oak Hill, VA (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/967,546

(22) Filed: Dec. 31, 2007

(51) Int. Cl. G06F 17/30; G06F 3/00

(52) U.S. Cl. 707/101; 707/102; 715/716; 707/E17.009

(57) ABSTRACT

Embodiments of a system for selecting a media file comprising a plurality of media, selecting one or more other media as alternate media, generating metadata specifying the one or more alternate media, and associating the metadata and the one or more alternate media to enable the media file to be alternately presented. Other embodiments are described.

### TECHNICAL FIELD

Embodiments of the invention relate to the field of data processing, and more particularly to methods and apparatuses for providing for selection and presentation of alternate media.

### BACKGROUND

In today's technological world, with the advent of low cost computing devices and the widespread use of computer networks, a user may readily enjoy multimedia content. The content is usually constructed according to the preference of the content provider. The end user of the content cannot customize the content based on his or her preferences. For example, a user may prefer soft music over hard rock music. But if a movie streamed to the user has hard rock music as its background music, the user is not able to replace the hard rock music with the music of his choice (i.e. soft music).

Using conventional demographic modeling techniques, content providers attempt to tailor the content according to the user's perceived preferences. However, increasingly, for privacy and other reasons, users generally do not want to make public or otherwise share their preferences with the content providers, making it difficult, if not impossible for the content providers to tailor their content based on user preferences.

### BRIEF DESCRIPTION OF THE DRAWINGS

Embodiments of the invention will be described by way of exemplary embodiments, but not limitations, illustrated in the accompanying drawings in which like references denote similar elements, and in which:

FIG. 1 is a block diagram of components for selecting and presenting a media file with alternate media and metadata in accordance with various embodiments of the invention;

FIG. 2 is a flow diagram illustrating a method for associating and providing alternate media and metadata with the media file in accordance with various embodiments of the invention;

FIG. 3 is a block diagram illustrating alternate presentation of a media file based on a local user profile in accordance with various embodiments of the invention; and

FIG. 4 is an exemplary block diagram of a computing system suitable for practicing the embodiments of the invention.

### DETAILED DESCRIPTION OF ILLUSTRATIVE EMBODIMENTS

Illustrative embodiments of the invention include, but are not limited to, methods and apparatuses for alternate presentation of media files.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in some embodiments” and “in various embodiments” are used repeatedly. These phrases generally do not refer to the same embodiment; however, they may. The terms “comprising,” “having,” and “including” are synonymous, unless the context dictates otherwise. The phrase “A and/or B” means “(A), (B), or (A and B)”. The phrase “A/B” means “(A), (B), or (A and B),” similar to the phrase “A and/or B”. The phrase “at least one of A, B and C” means “(A), (B), (C), (A and B), (A and C), (B and C) or (A, B and C)”. The phrase “(A) B” means “(B) or (A B)”, that is, A is optional.

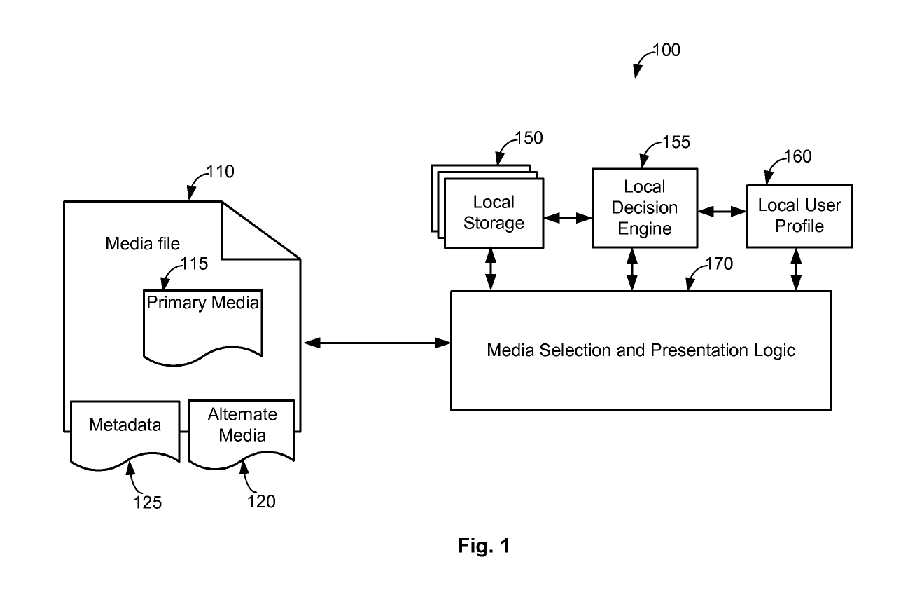

FIG. 1 is an overview of alternate presentation of a media file in accordance with various embodiments of the invention. As illustrated, in various embodiments, a media file 110 constructed in accordance with teachings of these embodiments may include a number of primary and alternate media 115 and 120, and metadata 125. Primary and alternate media 115 and 120 may be media of various forms, e.g., one or more audio media and/or one or more video media. In some embodiments, one or more audio media may mean one or more audio tracks or audio files; similarly, one or more video media may mean one or more video tracks or video files. The metadata 125 describe the primary and alternate media 115 and 120 respectively. The media file 110 may be, for example, any multimedia file which includes a video media and/or an audio media, for example, a movie, a video commercial, an audio/video clip, a television show, a game, such as, but not limited to an interactive game with both video and audio elements, etc.

The primary media 115 are presented when the media file 110 is presented in a standard or default manner. One or more of the primary media 115 may be replaced or substituted by one or more selected ones of the alternate media 120 in an alternate presentation. In some alternate presentations, the primary media 115 may be fully replaced by selected ones of the alternate media 120. While in other alternate presentations, the primary media 115 may only be partially replaced by selected ones of the alternate media 120. For example, media file 110 may comprise one or more primary video tracks, one or more primary audio tracks, and one or more alternate audio tracks. During an alternate presentation of the media file, one or more of the alternate audio tracks may be selected, e.g. because of a user's preference, to fully or partially replace one or more primary audio tracks, thereby providing the user with a “better” experience (“better” from the user's perspective). For example, in some embodiments, the user may chose to partially or fully replace the background music from a movie with alternate music that more suits the user's tastes.

Although referred as a media file, in some embodiments, the media file 110 may be a collection of one or more audio files, one or more video files, and/or the metadata 125. In some embodiments, alternate media, i.e. alternate audio media and alternate video media, means media that may be selectively employed instead of parts or all of the primary media, as well as in combination with the primary media during an alternate presentation. For example, the primary media may include the video and voice/sound effects tracks of a movie, while the part of the primary track that is replaced is the background music track, according to some embodiments of the invention.

In some embodiments, the media file 110 may not directly include the primary and/or alternate media 115 and 120, and/or the metadata 125; instead, the media file 110 may indirectly associate itself with the primary and/or alternate media 115 and 120, and/or metadata 125. In some of the embodiments, the term “directly” means the actual/physical inclusion of the primary and/or alternate media 115 and 120 and/or metadata 125 in the media file 110. In some embodiments, the term “indirectly” means the primary and/or alternate media 115 and 120 and/or metadata 125 are not actually/physically included in the media file 110, instead references, pointers and/or locators of the primary and/or alternate media and/or metadata are included in the media file. For example, in some embodiments, the media file 110 may include one or more links to the primary audio and/or video media, alternate audio and/or video media, and/or the metadata 125. Generally, the direct or indirect inclusion of each of primary and/or alternate media and/or metadata is independent. In other words, in some media files, the primary media and/or the metadata may be directly included, whereas the alternate media and/or the metadata may be indirectly included, while in other media files, it may be the other way around. Other combinations are possible.

In various embodiments, the metadata 125 may describe the primary/alternate media 115 and 120. For example, the metadata 125 may comprise a title, a SKU number, and so forth, which particularly identify a media. In other embodiments, the metadata 125 may generically or collectively specify or identify the alternate media. For example, the metadata 125 may comprise a genre, an artist name, or an album name to generically or collectively identify all titles of the genre, the artist or the album as alternate media. Further, the metadata could identify the meter, beat, relative volume, intensity, or other such musical characteristics of the alternate media.

In various embodiments, the media file 110 may include only metadata 125 describing the alternate media, and not include either directly or indirectly the described alternate media 120. In some of these embodiments, the alternate media may be considered effectively specified if the described alternate media is accessible to the user or device presenting the media file, in a remote or a local store, to be described more fully below.

Continuing to refer to FIG. 1, in various embodiments, alternate presentation of media file 110 may include the use of media selection and presentation logic 170. Media selection and presentation logic 170 is configured to selectively present media file 110 in either the primary manner or one of the alternate manners, replacing or substituting one or more of the primary media with selected ones of the alternate media. In various embodiments, media selection and presentation logic 170 analyzes metadata 125 to determine in an alternate presentation of media file 110, which if any of the primary media 115 may be replaced or substituted, and for the replaceable or substitutable one, which of the alternate media 120 should be selected to replace a particular primary media 115.

In various embodiments, media selection and presentation logic 170 analyzes metadata 125 and selects one or more alternate media 120 for an alternate presentation of the media file 110 in view of user preferences stored in local user profile 160, described more fully below.

In various embodiments, media selection and presentation logic 170 may be configured to analyze the metadata 125 and select the alternate media 120 for an alternate presentation, in view of user preferences stored in a local user profile 160, assisted by local decision engine 155, in whole or in part. In wholly assisted embodiments, media selection and presentation logic 170 may be configured to determine the presence of local decision engine 155, and invoke the local decision engine 155 to perform the analysis and selection, if its presence is detected. In partially assisted embodiments, media selection and presentation logic 170 may be configured to determine the presence of local decision engine 155, and invoke local decision engine 155 to perform selected aspects of the analysis and selection, if its presence is detected.

In various embodiments, regardless whether the analysis is performed by logic 170 or engine 155, analysis of metadata 125 may include determining how close the metadata 125 matches the user preferences 160 or which alternate media is least mismatched with the user preferences, as would be discussed in details later, described more fully below.

In various embodiments, logic 170 may be configured to access local storage 150 for a matching or least mismatched alternate media that is not included in the media file 110, but stored in local storage 150. In some embodiments, alternate media may also be obtained from other remote storage (not shown).

In various embodiments, the local decision engine 155 and/or the media selection and presentation logic 170 may be implemented in hardware and/or software, or combination thereof, for example, by a digital signal processor (DSP), with appropriate software. Local storage 150 may be any one of a number of storage medium, such as non-volatile memory, magnetic or optical disk and so forth. Further, user profile 160 may also be stored in local storage 150 together with various media available locally.

Referring back to FIG. 1, in various embodiments, local media files stored in the local storage 150 may include associated local metadata which may include appropriate information about the associated local media files, including, for example, title, duration, artist, album, album cover artwork image, and/or the genre information. Examples of genre of an audio media file may include, for example, jazz, hard rock, classical, blues, pop, instrumental, country, etc. In some embodiments, if a local audio media file is stored in the MP3 format, an ID3 tag of appropriate version (e.g., ID3v1 or ID3v2) may be used as local metadata.

In various embodiments, the user profile 160 may keep track of some or all the media files played by the user and/or some or all the media files downloaded and stored in the local storage 150, including storing information about the title, duration, artist, album, album cover artwork image, genre, and/or any metadata associated with the audio files, and/or the frequency with which the user accesses the media files. In some embodiments, the local user profile 160 stores a preferred list of audio tracks, songs, music, artists, genres, types, and/or languages of audio tracks, previously accessed genres of songs, etc. The user profile 160 may be partially or fully customizable by the user of the system 100. The user may, for example, modify some or all the preferences stored in the user profile 160.

In some embodiments, the user of the system 100 may limit or restrict access to the user profile 160 by a provider of the media file 110 and/or any other service provider. For example, if the media file 110 is streamed or downloaded from a website, the website or an associated server may not be authorized to access the local user profile 160. This ensures privacy of the user preferences included in the local user profile 160, without sacrificing the abilities to tailor or customize the media file 110 by the system 100.

In various embodiments, local decision engine 155 may also assist in generating and/or modifying the user preferences in a local user profile 160. In various embodiments, local decision engine 155 may generate and/or modify the user preferences using any one of a number of learning methods. In alternate embodiments, user preferences may be generated and/or modified by other entities.

In various embodiments, regardless whether the metadata analysis is performed by logic 170 or engine 155, logic 170 and engine 155 may determine there is a match between the metadata 125 and a user preference if there is an exact match, e.g. a title is included among metadata 125 and also logged as a frequently played, or an encompassing match, e.g. a genre included in the metadata 125 encompasses the favorite titles stored in user profile, or vice versa. In various embodiments, logic 170 and engine 155 may determine there is a least mismatch between metadata 125 and a user preference employing e.g. a similar/dissimilar or distance function. In alternate embodiments, similarity/dissimilarity may be determined in other manners.

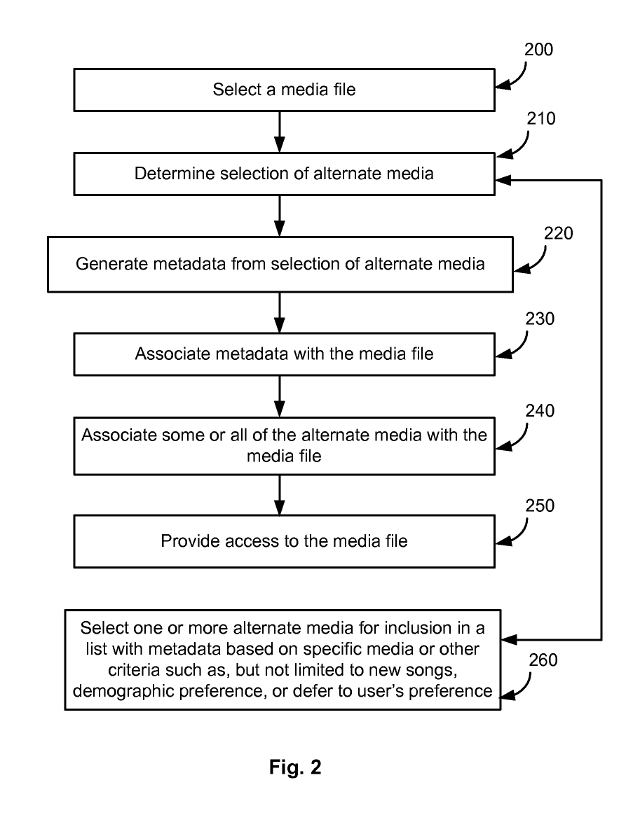

FIG. 2 is an exemplary flow diagram illustrating a method for selecting and associating alternate media 120 and/or metadata 125 with the media file 110 in accordance with various embodiments of the invention. Alternate media 120 and/or metadata 125 may be generated and/or associated with the media file 110 by a generator of the media file 110. For the purpose of this disclosure and unless otherwise stated, “generator of the media file” may refer to a person or a device that selects, generates and/or associates the metadata 125 and/or alternate media 115 with the media file 110. For example, if the media file 110 is provided by a website, the server of the website, the webmaster, and/or any authorized device or person may be the generator. Alternately, if the user of the system 100 generates the metadata 125, the user may be the generator.

At 200, a media file 110 is selected. The selected media file 110 may already directly or indirectly include primary media 115. At 210, the generator of the media file 110 determines a selection of alternate media 120, one or more of which may partially or fully replace one or more primary media 115 during an alternate presentation of the media file 110. In some embodiments, selected alternate media may include one or more audio tracks, genres, artists, titles, and/or albums.

The generator may select one or more alternate media for inclusion in a list in the metadata 125 based on specific media or other criteria such as, but not limited to most played/popular songs, most played/popular genres, new songs (just released), etc, as shown in 260. The alternate media selection may also depend on, for example, the mood, intensity, or flavor of the primary media to be replaced. For example, for a slow, romantic movie, the selected alternate media may be classical, jazz, or country music; but these genres may be inappropriate for an intense video game.

In some embodiments, several other factors may be considered while selecting the alternate media. For example, the metadata 125 may specify the meter, beat, and/or relative volume of the alternate media 120, apart from specifying other information like genre or artist. In some embodiments, the metadata 125 may also specify a preferred manner in which the alternate media should be presented during alternate presentation. In some embodiments, the metadata 125 may include information regarding the spatial relationship of the alternate media. The metadata 125 may specify, for example, to present a drum track of the alternate media on the left rear speaker and a guitar track on the right front speaker, while replacing a particular segment of one or more primary media. The metadata 125 may include numerous other information about the alternate media, including fade in (increase) and fade out (decrease) volume of the alternate media.

At 220, the metadata 125 is generated for the selected alternate media, where the metadata 125 may be partially or wholly associated with the alternate media selected at 210. The metadata 125 may include information about the selected alternate media. In some embodiments, the metadata 125 may include a list of selected alternate media, including a list of songs, albums, artists, genres, and/or titles of the selected alternate media. The metadata 125 may also indicate the part of the primary media 115 that may be replaced with one or more of the selected alternate media during an alternate presentation of the media file 110. At 230, the metadata 125 is associated with the media file 110, i.e. directly or indirectly included in the media file 110.

At 240, some or all the selected alternate media is associated with the media file 110, i.e. directly or indirectly included in the media file 110. In some embodiments, 240 is optional, and the alternate media is not included, either directly or indirectly, in the media file 110; rather, the metadata 125 includes information about the selected alternate media.

At 250, the system 100 is provided access to the media file 110 with the primary media 115, metadata 125, and/or the selected alternate media 120.

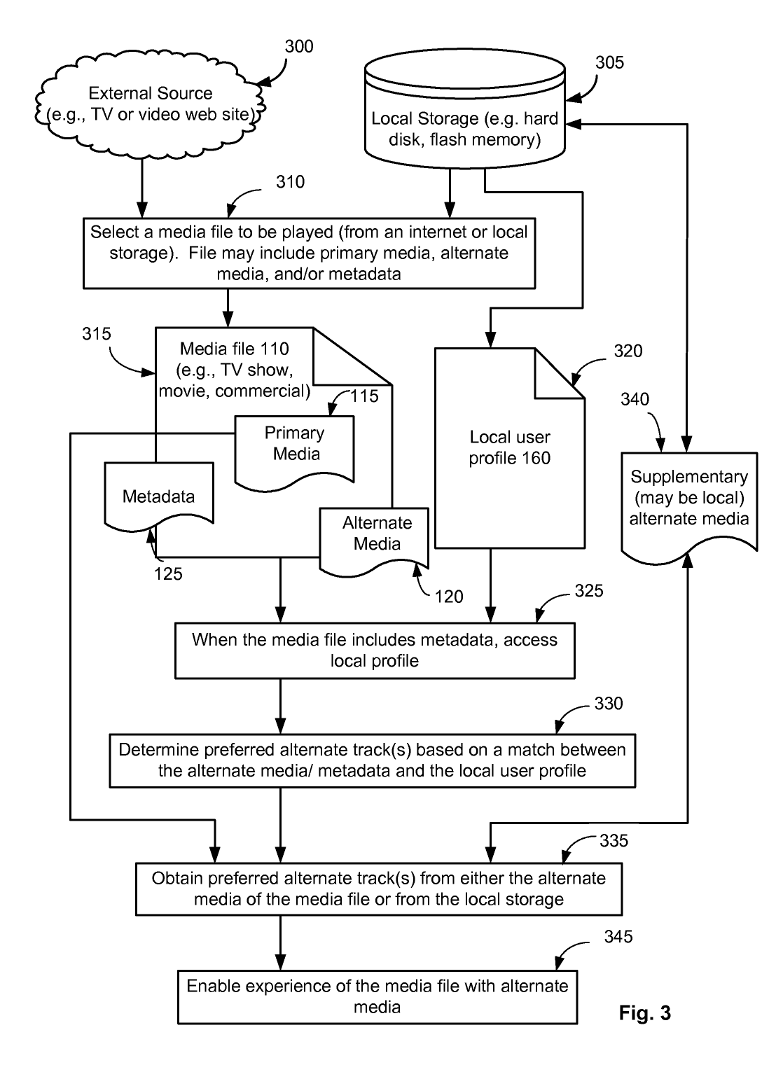

FIG. 3 is an exemplary block diagram illustrating alternate presentation of the media file 110 based on the local user profile 160 in accordance with various embodiments of the invention. At 310, the media file 110 may be received from either an external source 300 or from a local storage 305. The external source 300 may include, but not be limited to any appropriate source delivering media file over a network such as the internet, a television network such as a cable television or a satellite television network, a P2P network, an intranet, a file sharing network, a local area network such as an in-home wired or wireless home network, etc. The received media file 110 may directly or indirectly include the primary media 115, metadata 125, and optionally the selected alternate media 120, as shown in 310 and 315. As discussed earlier, a local user profile 160 may already be generated at 320.

When the media file 110 includes metadata 125, media selection and execution logic 170 and/or the local decision engine 155 analyzes metadata 125 in view of user preferences stored in the local user profile 160 at 325. At 330, the media selection and execution logic 170 may determine preferred alternate media based on a match (or least mismatch) of the alternate media 120 and/or metadata 125 with user preferences stored in the local user profile 160.

For example, in some embodiments, the metadata 125 may directly specify the alternate media, i.e., for example, include a list of audio tracks as the alternate media 120. If one of the audio tracks in this list directly matches with a preferred audio track listed in the local user profile 160, or generically matches with a preferred genre listed in the local user profile, the audio track may be determined as a preferred alternate audio track.

In some embodiments, the alternate media may be specified collectively, for example, as a list including one or more artists, genres, and/or albums. If the collectively specified alternate media generically matches with a preferred audio track listed in the local user profile 160, the audio track is selected as a preferred alternate audio track. For example, hard rock genre may be specified as alternate media in the media file 110. If an audio track with hard rock music is in the preferred audio track list of the local user profile 160, that audio track is selected as a preferred alternate audio track.

If none of the audio tracks or genres specified as alternate media in the media file 110 matches with the preferences of the local user profile 160, an audio track/genre of the local user profile 160 that least mismatches with one or more of the alternate media may be determined as a preferred alternate audio track. For example, jazz may be specified as alternate media for the media file 110 whereas the local user profile 160 may include classical, hard rock, hip hop, and blues, but not jazz, as preferred genres. The media selection and execution logic 170 may determine that classical music genre from the local user profile 160 least mismatches with jazz listed in the metadata 125 because of some musical similarities between jazz and classical music, and consequently, the media selection and execution logic 170 may determine classical music as a genre of the preferred alternate audio track, and any appropriate classical audio track as a preferred alternate audio track. As would be readily understood by someone skilled in the art, other ways of determining preferred alternate audio track may be easily envisioned.

In some embodiments, the metadata 125 may not include any information about alternate media, and any preferred genre/song/album/artist listed in the user profile 160 may be selected as a preferred alternate audio track. In some embodiments, the user may select a specific audio track as a preferred alternate audio track.

At 335, the media selection and execution logic 170 may obtain the preferred alternate audio track(s) from the alternate media 120 included in the media file 110, from supplementary audio tracks 340 available from the local storage 305, and/or from any other source accessible to the system 100. At 345, the system 100 or the computing device 500 may customize the media file 110 (prior to or dynamically during the alternate presentation) by partially or fully replacing one or more of the primary media 115 with one or more of the preferred alternate track(s) obtained at 335, present the media file with the alternate tracks in an alternate manner, and enable experiencing the media file with alternate tracks.

The inventive principles disclosed herein may be used in a variety of manner. For example, in some embodiments, a user visits an internet website and requests viewing a video commercial. A part of the default background music of the commercial may be jazz, but a metadata included in the commercial may specify other genres, for example, classical, blues, hip hop, etc. as alternate media. A user profile stored in the user's computing device may specify hip hop as a preferred genre. The computing device of the user streams/downloads the relevant media file, accesses the user profile, replaces part of the default background music with an appropriate audio track with hip hop music without affecting the voice and other sound tracks of the commercial, and presents an alternate version of the commercial in the user's computing device.

In some embodiments, one or more alternate media may be presented in addition to the primary media, instead of replacing the primary media. For example, there may be certain scenes in a movie without any default or primary background music. The media selection and execution logic 170 may add background music to those scenes based the preferences set in the user profile 160 and/or the alternate media and/or the alternate media metadata received with the movie. In such a case, the alternate media is presented in addition to the primary media, instead of replacing the primary media. As would be apparent, one or more alternate media may be presented in addition to the primary media, while, at the same time, other alternate media may replace one or more of the primary media.

The inventive principles may be readily applied to computing devices with multiple users. For example, if a computing device, e.g., a computer, has multiple users with individual login, individual user profile may be generated for individual user.

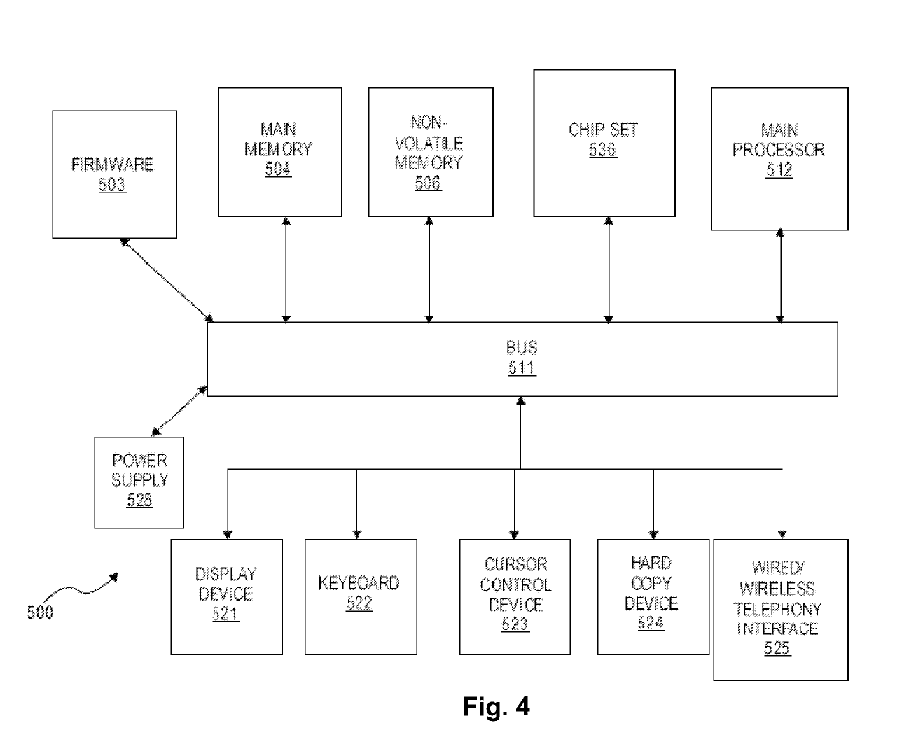

FIG. 4 illustrates a block diagram of an example computer system that may be suitable for practicing some embodiments of the invention, including the systems of the media provider, providing the media files, and the client device making the selection of primary and alternate media. In some embodiments, computer system 500 includes a communication mechanism or bus 511 for communicating information, and an integrated circuit component such as a processor 512 coupled with bus 511 for processing information.

Computer system 500 further comprises a random access memory (RAM) or other dynamic storage device 504 (referred to as main memory) coupled to bus 511 for storing information and instructions to be executed by processor 512. Main memory 504 also may be used for storing temporary variables or other intermediate information during execution of instructions by processor 512.

Firmware 503 may be a combination of software and hardware, such as Electronically Programmable Read-Only Memory (EPROM) that has the operations for the routine recorded on the EPROM. The firmware 503 may embed foundation code, basic input/output system code (BIOS), or other similar code. The firmware 503 may make it possible for the computer system 500 to boot itself.

Computer system 500 also comprises a read-only memory (ROM) and/or other static storage device 506 coupled to bus 511 for storing static information and instructions for processor 512. The static storage device 506 may store OS level and application level software.

Computer system 500 may further be coupled to a display device 521, such as a cathode ray tube (CRT) or liquid crystal display (LCD), coupled to bus 511 for displaying information to a computer user. A chipset, such as chipset 536, may interface with the display device 521.

An alphanumeric input device (keyboard) 522, including alphanumeric and other keys, may also be coupled to bus 511 for communicating information and command selections to processor 512. An additional user input device is cursor control device 523, such as a mouse, trackball, trackpad, stylus, or cursor direction keys, coupled to bus 511 for communicating direction information and command selections to processor 512, and for controlling cursor movement on a display device 512. A chipset, such as chip set 536, may interface with the input output devices.

Another device that may be coupled to bus 511 is a hard copy device 524, which may be used for printing instructions, data, or other information on a medium such as paper, film, or similar types of media. Furthermore, a sound recording and playback device, such as a speaker and/or microphone (not shown) may optionally be coupled to bus 511 for audio interfacing with computer system 500. Another device that may be coupled to bus 511 is a wired/wireless communication capability 525.

Computer system 500 has a power supply 528 such as a battery, AC power plug connection and rectifier, etc., as one of ordinary skill in the relevant art would appreciate based at least on the teachings provided herein.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the invention. This application is intended to cover any adaptations or variations of the embodiments discussed herein. Therefore, it is manifestly intended that the embodiments of the invention be limited only by the claims and the equivalents thereof.

1. A method comprising:
selecting a media file, wherein the media file includes at least a primary media;
selecting one or more alternate media to be associated with the media file;
generating metadata specifying the one or more alternate media to be selectable in place of the primary media; and
associating the metadata of the one or more alternate media with the media file to enable the media file to be alternately presented.

2. The method of claim 1, wherein the primary and alternate media include at least one of an audio track, a video track, or an information track.

3. The method of claim 1, wherein the metadata includes information about the primary media, the alternate media, or the media file, and wherein the information of the metadata includes at least one of the name, duration, genre, language, demographic preference, or primary or alternate status of the media.

4. The method of claim 1, further comprising:
associating the alternate media with the media file.

5. The method of claim 1, wherein associating includes at least one of modifying the media file to include the metadata or modifying the media file to include a reference to the metadata.

6. The method of claim 1, further comprising:
distributing the media file.

7. A method comprising:
receiving a media file with associated metadata about a primary media and one or more alternate media, wherein the media file includes the primary media and at least an association to the one or more alternate media, and wherein the metadata includes information about the primary media, the alternate media, or the media file, and wherein the information of the metadata includes at least one of the name, duration, genre, language, demographic preference, or primary or alternate status of the media;
analyzing the metadata in comparison with one or more preferences accessible from a local user profile;
from the analysis, selecting at least one of the one or more alternate media; and
presenting the media file with the at least one of the one or more alternate media replacing a primary media.

8. The method of claim 7, wherein the primary and alternate media include at least one of an audio track, a video track, or an information track.

9. The method of claim 7, wherein the primary media is only partially replaced.

10. The method of claim 7, wherein the one or more alternate media is associated by one or more of name, duration, genre, language, demographic preference, or primary or alternate status of the media.

11. The method of claim 7, wherein the one or more preferences of the local user profile indicate at least one of i) that only locally stored alternate media is to be selected, ii) that specific alternate media is to be selected regardless of the information included in the metadata, or iii) that only alternate media matching certain specific criteria from the information in the metadata are to be selected.

12. The method of claim 7, wherein the media file is at least one of a movie, series program, advertisement, or game.

13. An apparatus comprising:
a media selection and presentation logic configured to receive a media file with associated metadata about a primary media and one or more alternate media, wherein the media file includes the primary media and at least an association to the one or more alternate media, and wherein the metadata includes information about the primary media, the alternate media, or the media file, and wherein the information of the metadata includes at least one of the name, duration, genre, language, demographic preference, or primary or alternate status of the media;
a local user profile to store one or more preferences about media;
a local decision engine to analyze the metadata in comparison with the one or more preferences accessible from the local user profile, and select at least one of the one or more alternate media; and
a local storage configured to store at least one of the local user profile, one or more media files, or supplementary alternate media;
wherein the media selection and presentation logic is configured to present the media file with the at least one of the one or more alternate media replacing a primary media.

14. The apparatus of claim 13, wherein the primary and alternate media include at least one of an audio track, a video track, or an information track.

15. The apparatus of claim 13, wherein the primary media is only partially replaced.

16. The apparatus of claim 13, wherein the one or more alternate media is associated by one or more of name, duration, genre, language, demographic preference, or primary or alternate status of the media.

17. The apparatus of claim 13, wherein the one or more preferences of the local user profile indicate at least one of i) that only locally stored alternate media is to be selected, ii) that specific alternate media is to be selected regardless of the information included in the metadata, or iii) that only alternate media matching certain specific criteria from the information in the metadata are to be selected.

18. The apparatus of claim 13, wherein the media file is at least one of a movie, series program, advertisement, or game.

19. The apparatus of claim 13, wherein the local decision engine is further configured to prevent information from at least one of i) the local user profile, ii) the local decision engine or iii) the media selection and presentation logic from at least one of a) leaving the apparatus or b) being provided by the apparatus to a provider of the media file.

20. The apparatus of claim 13, further comprising:
a display on which the media file is to be presented.
